(19) United States
(12) Patent Application Publication
(10) Pub. No.: US 2001/0039594 A1
(43) Pub. Date: Nov. 8, 2001

(54) Method for enforcing workflow processes for website development and maintenance

(76) Inventors: Britt H. Park, Mountain View, CA (US); Kevin Cochrane, San Francisco, CA (US)

Correspondence Address: Derek J. Westberg, Stevens & Westberg LLP, Suite 201, 99 North First Street, San Jose, CA, 95113, US

(21) Appl. No.: 09/727,127

(22) Filed: Nov. 29, 2000

Related U.S. Application Data
(63) Continuation-in-part of application No. 09/244,333, filed on Feb. 3, 1999.
(60) Provisional application No. 60/168,156, filed on Nov. 29, 1999.

(51) Int. Cl. G06F 15/163; G06F 17/30

(52) U.S. Cl. 709/311; 707/104.1; 707/513; 707/530

(57) ABSTRACT

A method for enforcing workflow processes for website development and maintenance. Development and maintenance of a website may include the concerted efforts of plural persons. So that the work progresses in a predictable and orderly fashion, tasks are assigned and performed in accordance with a workflow. The workflow is an arrangement of tasks to be performed. The arrangement may include tasks performed in serial order, in parallel with each other or in combinations of serial and parallel. To enforce a particular workflow, the present invention provides an environment that constrains work to progress according to the workflow. An administrator, such as a “webmaster,” develops a workflow file that dictates how the efforts of users (or “contributors”) should progress. Accordingly, the webmaster has increased control over the processes by which the website is developed and updated. As a result, website development proceeds efficiently even where many persons are involved in the effort.

This application claims priority of U.S. Provisional Application Ser. No. 60/168,156, filed Nov. 29, 1999. This application is a continuation-in-part of U.S. patent application Ser. No. 09/244,333, filed Feb. 3, 1999.

### FIELD OF THE INVENTION

The present invention relates to the field of website development and maintenance. More particularly, the present invention relates to control and administration of processes utilized for website development and maintenance.

### BACKGROUND OF THE INVENTION

The Internet is playing a large role in commerce, and most companies tend to have a website. It is often a challenge to develop large websites due to the need to coordinate the efforts of many contributors. Further, many websites need to be frequently modified, and contributors usually modify them in an ad hoc process. Consequently, the on-going process of keeping website content up to date, accurate, and well integrated is often a great challenge. Internet sites may be updated by the day, hour or minute, by teams numbering in the hundreds. Similarly, intranet content contributors constantly submit new content or make changes to existing content, and unless the new content is quickly and accurately integrated, the intranet's usefulness as a fundamental communications resource is limited.

Large websites face many problems as the number of web contributors increase exponentially. The volume and content of these sites is increasing rapidly and, and sites must be updated more frequently as site traffic and Internet commerce grows. With the increasing number of contributors, volume, and complexity of content, it has become increasingly more difficult for the manager of the website (“webmaster”) to oversee every change and perform quality control.

Because of the complexity of website development, there is a need for a central system to manage and control website development. Known systems for managing and controlling website development include software configuration management systems, document management systems, and database publishing systems.

There are several disadvantages associated with such known website development systems. For instance, because maintaining a website often requires the efforts of tens or hundreds of people, it is desirable to have website contributors work in parallel. Software configuration management systems do not allow contributors to simultaneously make changes to the same area of a website. Moreover, none of the known systems allow contributors working in parallel to separately test their own work without actually making a change to the website. Thus, conflicting changes may be posted to a website causing the website to be corrupted.

Since contributors cannot foresee on an individual level the effects of their work when combined with other's contributions, known systems rely on a webmaster to integrate all changes posted to a website and check the changes for errors. A webmaster also ensures that contributors only change content they are authorized to change. However, the webmaster often becomes a bottleneck for the website development process because the webmaster must do all the integration and testing of changes to a website. Integrating the work of multiple users is manual and time consuming, and a great deal of time is wasted on bug fixing and resolving conflicts, while too little time is invested in design, innovation and strategy. Moreover, a webmaster cannot easily oversee a contributor's progress on a change until the contributor is ready to submit the change to the webmaster. Thus, the webmaster cannot correct errors early on and cannot determine how contributors are progressing.

Another disadvantage of known website development systems is that they do not allow the webmaster to determine ahead of time how the work involved in updating to a website should progress and provide a mechanism by which the work progresses according to the plan. Without such a planning ability, the webmaster has limited control over the efforts of contributors, resulting in low efficiency and the need to make numerous modifications as contributors submit their changes. For example, where several different tasks relating to the development or maintenance of a website are assigned to different persons, each at a different workstation, their efforts will be most efficient if they are organized and coordinated.

Therefore, what is needed is a technique for organizing the development and maintenance of a website. More particularly, what is needed is such a technique in which an administrator may control the efforts of several website developers.

### SUMMARY OF THE INVENTION

A method for enforcing workflow processes for website development and maintenance. Development and maintenance of a website may include the concerted efforts of plural persons. So that the work progresses in a predictable and orderly fashion, tasks are assigned and performed in accordance with a workflow (also referred to herein as a job). The workflow (or job) is an arrangement of tasks to be performed. The arrangement may include tasks performed in serial order, in parallel with each other or in combinations of serial and parallel. To enforce a particular workflow, the present invention provides an environment that constrains work to progress according to the workflow.

Each person may make his or her contributions to the website by performing assigned tasks in a corresponding work area. Each task may include making changes, such as additions, deletions or alterations, to data contained in a particular file or files. Thus, a task may include changing an existing file, but may also including creating a new file. A work area typically resides in central server. However, in distributed processing environment, the work area may include assigned memory space, such as in a workstation.

Upon completion of a task, approval of the work performed may be required by one or more entities before further work is done to the resulting file or files. If the work is rejected, then the files may be returned for further changes. For example, a task may include updating a page of the website to reflect new marketing information. The work may be performed by a first person, such as a web programmer in a company's information systems department. Prior to deploying the resulting files such that the new marketing information is integrated into the website, review and approval of the work may be required. Review and approval of the completed work may be performed a second person, such as a representative of the company's marketing department.

An administrator, such as a “webmaster,” develops a workflow file that dictates how the efforts of users (or “contributors”) should progress. Accordingly, the webmaster has increased control over the processes by which the website is developed and updated. As a result, website development proceeds efficiently even where many persons are involved in the effort.

### BRIEF DESCRIPTION OF THE DRAWINGS

FIG. 1 illustrates a computer network system for website development in accordance with the present invention;

FIG. 2 illustrates an exemplary assign-edit-approve workflow model in accordance with the present invention;

FIG. 3 illustrates an exemplary job instance created from the workflow model of FIG. 2;

FIG. 4 illustrates five main components which may be utilized in accordance with the present invention to set up a workflow template to a create a job; and

FIGS. 5 through 8 illustrate exemplary workflows in accordance with the present invention.

### DETAILED DESCRIPTION OF A PREFERRED EMBODIMENT

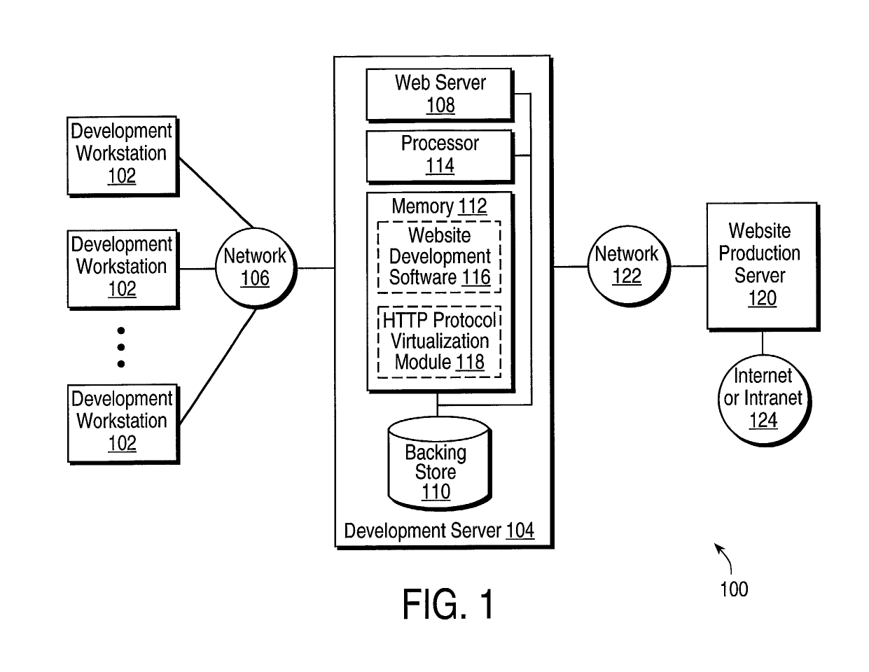

FIG. 1 illustrates a computer network system 100 for website development. On development workstations 102, website developers may add, remove, edit and examine files for a website. Development workstations 102 may include conventional personal computers, UNIX workstations, or other workstations that can be configured to develop content. The development workstations 102 may be connected to a development server 104 via a computer network 106, such as the Internet or a local area network (LAN).

The development server 104 includes a web server 108 for serving up content to web browsers, and a backing store 110 for storing versions of website content. The server 108 processes hypertext transfer protocol (HTTP) requests from the development stations 102 for website content (e.g., files). The website files may be physically stored in the backing store 110 which may be conventional, such as the WINDOWS NT files system commercially available from Microsoft Corporation.

The development server 104 may also include a conventional memory 112 (e.g., RAM) and a conventional processor 114, which implements the website development methods of the present invention by executing software 116 stored in the memory 112. An HTTP protocol virtualization module 118 which the processor 114 executes to allow web server 108 to operate as if it were multiple servers may also be stored in the memory 112.

The development server 104 may be coupled to a website production web server 120 via a network 122. Network 122 may be the same network as network 106 or a different network. The web server 120 may also be coupled to the Internet or an intranet 124. When a website is ready to be posted on the World Wide Web or on an intranet, the development server 104 sends the website content to the production web server 120 which then provides Internet or intranet access to the website.

A website is generally comprised of the contents of an arbitrary file system. The website development system 100 of the present invention may include hierarchical file systems. Each such file system of the present invention provides an environment for managing and manipulating individual files. When executed, the website development software 116 part of the file system enables the management and manipulation of files. The backing store 110 is where the files and corresponding metadata (e.g., owner identification, group identification, access control, file name, modification times, creation times, etc.) may be physically stored.

A hierarchical file system of the present invention is referred to as an “area.” There may be different types of areas including work areas, staging areas and edition areas. A work area is typically a modifiable file system that is used by persons who create and maintain web content for eventual use in a website.

A staging area is usually an area where content is assembled before it is published. Since the work areas are generally areas for creating and maintaining content exclusively, the staging area (and the edition area), may be restricted to only assembling and displaying content. By design then, the staging and edition areas may be configured as read-only file systems. Any modifications to content may then be sent from an editor back to a workstation to perform any changes that may be needed. Thus, a task for which content is modified may reference content in a staging or edition area but with the modifications actually taking place in a work area. This helps to maintain the integrity of the content and to simplify the process. However, a business may want the system 100 to be more flexible, allowing other people such as editors to modify the content directly before it is published. The staging and edition areas may then be configured as modifiable file systems. Thus, in such an embodiment, content submitted from work areas may be edited in a staging area or in an edition area.

A work area may initially include a virtual copy of an entire website (unless there is no existing website, in which case the work area may be empty). In other words, a work area may initially have the same contents as the file system designated as the website. A work area provides a developer's personal view of a website in which the developer may contribute to the website. For example, in a work area, developers can freely add, delete and modify website content and see how their changes fit into the context of the entire website. Changes made by developers in work areas preferably do not affect the website or the work of other contributors in other work areas. This is because each work area may be a separate file system. Typically, a work area is located at a workstation 102.

Developers may integrate their work in a staging area by submitting the contents of their work areas into a staging area. The staging area is a file system available to multiple developers that provides a shared view of the website. Thus, a staging area may hold the collective work of several developers' work areas and may allow the developers to share and integrate their changes. In a staging area, the developers can see how their changes fit together. The staging area is typically located at the development server 104.

Copying is said to be “virtual” where areas share directory trees such that the directory trees do not have to be physically copied. The collective work in a staging area changes as different contributors submit new content from work areas. Work areas are most effective when the content and other information in the staging area is virtually copied back to one or more private work areas. This helps to keep the individual work areas up-to-date with respect to the staging area while contributors are performing website related tasks such as creating and maintaining content.

When the collective work in a staging area is deemed final, its contents can be published to create an edition of the website. This may be accomplished by virtually copying contents of a staging area onto an edition area. Because an edition is typically a read-only file system, it is a frozen snapshot of the content of the entire website. Each edition taken at sequential points in the development of a website may be archived and accessible to all developers so that developers may instantly recall files, entire directories, or reconstruct entire past versions of the website. For example, the contents of an edition may be virtually copied into a work area to be used as a basis for further development of the website. An edition area is typically located in the development server 104. Content (e.g., an edition) in the development server 104 may be deployed to the production server 120.

So that the website development and maintenance work progresses in a predictable and orderly fashion, tasks are assigned and performed in accordance with a workflow configuration (also referred to herein as a job). The workflow (or job) is an arrangement of tasks to be performed. The arrangement may include tasks performed in serial order, in parallel with each other or in combinations of serial and parallel. The present invention provides an environment that constrains work to progress according to a workflow.

A workflow model is a general workflow configuration that can be used repeatedly. Each workflow model describes a process that can include user tasks and wide variety of automated tasks. Workflow models are typically designed by business managers and configured by a system administrator.

Two components of the system 100 may implement the workflow techniques in accordance with the present invention. First, a server-side subsystem (also referred to as a “workflow subsystem”), which provides a framework for controlling website production, may be included in the development server software 112. Second, a client-side user interface may be provided in the workstations 102. For example, the client-side user interface enables the developers to enter data and to control specific workflow actions. The client-side user interface is typically a web-based common gateway interface (CGI), such as a web browser written in HTML and Perl scripted.

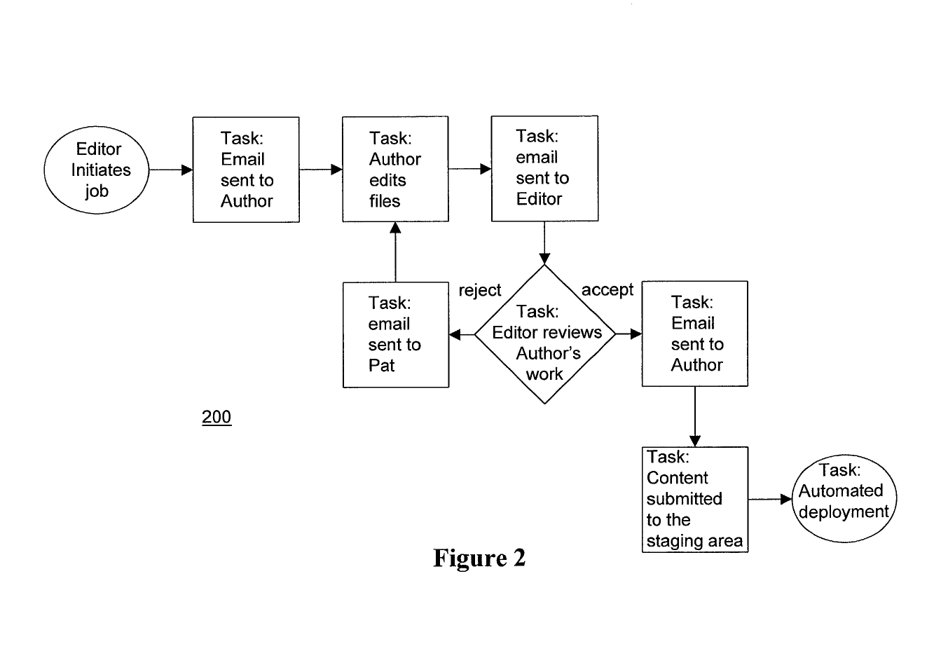

FIG. 2 illustrates a simple assign-edit-approve workflow model 200. Email may be sent to the participants (e.g., developers who have roles of author and editor) at every stage of the process, and automated tasks may be performed at the end.

A set of interdependent tasks may be referred to as a “job.” One example of a job would be a set of tasks needed to prepare a new section in a marketing website to support a new product launch. A description of a workflow model may also be called a “job specification.” A job specification file may describe a single job and may be stored in the memory 112 (FIG. 1). The job specification file is preferably structured as a hierarchy of sections, each containing an element definition that provides for control of a job parameter. An initial “<workflow>” section defines the overall characteristics of the job. This may include the job's name, owner, creator and a description of what the job does.

A task is a unit of work performed by a single user or process. Each task in a job is associated with a particular area (e.g., a work area) and carries a set of files with it. The user or process owning a task can modify, add files to, or remove files from the task (provided the task is not a read-only task, such as for content approval).

One or more task sections that describe specific tasks to occur as part of the job follow the initial <workflow> section of the job specification file. The following is an exemplary list of elements that can define sections in a job specification: <usertask>; <updatetask>; <submittask>; <extemaltask>; <endtask>: <grouptask>; and <cgitask>. Each of these task elements may include: the owner of the task, which may be the user who is responsible for completing the task; a name for the task, which uniquely identifies the task within its job; a start attribute, which specifies whether the task should be active upon invocation of the job that contains the task; a description of what the task does; a lock attribute, which specifies whether the task will attempt to acquire locks on its associated files when it becomes active (this is to prevent conflicts that may occur if another task were to modify the files); a read-only attribute, which may restrict a user from adding, removing or modifying files; an area path, which may identify an area in which the task is to be performed; a timeout limit for completion of the task (e.g., when the timeout is exceeded, the task may be deactivated and next task element activated); an identification of files that are to be affected by the task; an indication as to when the task is to become active (e.g., when signaled by a preceding task); an indication as when the task is to become inactive (generally each task becomes inactive when it signals a next task, but may also need to be inactivated under other circumstances such as when one of several reviewers rejects a completed task so as to prevent the other reviewers from unnecessarily reviewing it); an identification of any other tasks that are to be reset upon activation of the task (when reset, those tasks are set to a state of not having been activated by another task); and an identification of any extended attributes of files associated with the task that are to be set, modified or deleted upon activation or deactivation of the task.

In addition to the above, the <usertask> element may also define user tasks that are to appear on a particular user's task list. A sub-element of <usertask> may specify possible alternative sets of successor tasks to signal when the task is completed (e.g., mark “done,” reject, approve). The <grouptask> element may define user tasks that are to appear on the task lists of a particular group of users. A sub-element of <grouptask> may specify an arbitrary set of users who share the group task. The <externaltask> element may specify any external programs to be run when it becomes active and any arguments to be passed between the task and the external program. The workflow subsystem is preferably notified when the external program is complete. The <submittask> element may perform a submit operation (to a staging area) on its contained files. If successful, specified successor tasks may be signaled. If not successful, the user may be notified to resolve any conflicts. The <updatetask> element may obtain the latest version of its associated files (e.g., from a staging area or another workstation). The <endtask> element may indicate the end of a job. When an <endtask> element becomes active, its containing job may be terminated and all locks held by the job released. The <cgitask> element may behaves much like an external task except that it does not run the specified external program and, instead, relies upon the user to run the program through the user interface. Thus, similar to <externaltask>, the workflow subsystem is preferably notified when the specified external program is complete.

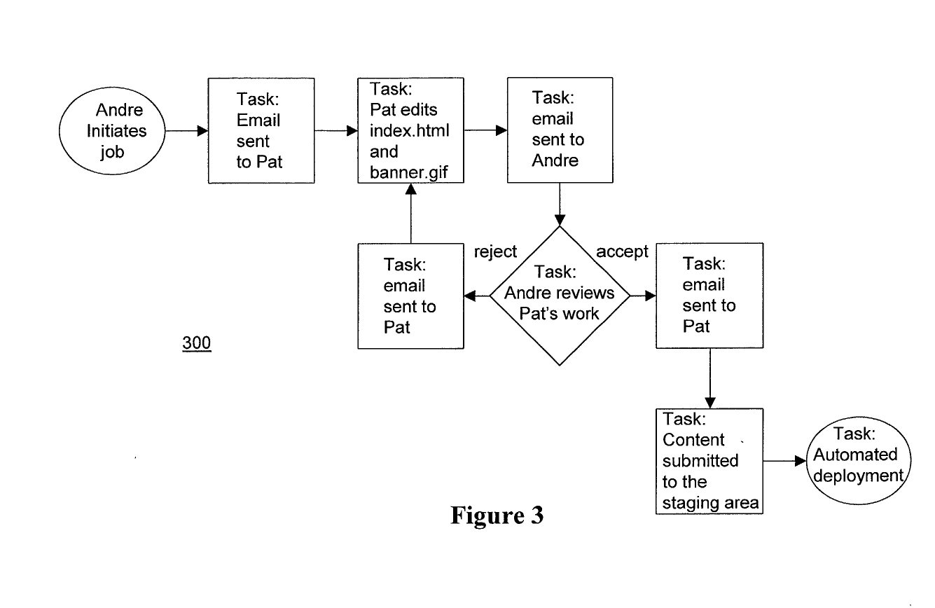

Job creation is generally a two-step process. A first step is to activate a job specification, such as by loading it into the workflow subsystem. The job specification is then said to be a “job instance.” A job is preferably not active, however, until it is invoked. Thus, a second step is to activate the job. Each job is a specific instance of a workflow model. When a job is created, the job creator must supply all the specific information for that job. For example, the workflow model of FIG. 2 may be utilized to create a job instance 300 as illustrated in FIG. 3.

On creation, jobs follow predefined workflow models. Thus, tasks generally cannot be added to or removed from individual jobs. However, if specified on job creation, certain attributes of the job, such as its owner, may be modifiable by a user or system administrator. By specifying jobs and limiting the ability of users to modify them, the website administrator controls website development and maintenance processes through the workflow models and job specifications.

Tasks preferably have two possible states: active and inactive. A task becomes active when its predecessor tasks signal it to do so; predecessor tasks and conditions for activation can be configured as part of the workflow model. After the task has been activated, users or external programs can do work on it. For example, after a user task has been activated, the user can work on the files contained in the task. After an external task has been activated, the appropriate external program can run on the files contained in the task. Inactive tasks are tasks that have been completed, or that have not been activated yet. Tasks can also be designated as read-only or editable. A read-only task may allow users to approve and comment on content without being able to edit, delete, add, or remove files from the task.

Preferably, a job may be created in one of two ways. First, a job specification file [e.g., an extensible markup language (XML) file] that defines a single job may be directly edited. Alternately, a job may be created through a combination of workflow rules defined in a workflow template file (e.g., an XML file) and end-user input from the browser interface. With this second technique, a single workflow template file may be created to define multiple jobs that differ depending upon what input is provided. The workflow rules of the template and user input (e.g., from a website administrator) may be interpreted by a common gateway interface (CGI) to dynamically create a job specification file. This may be the same type of file that would be created using the “manual” direct-edit technique described above. Once configured, this technique simplifies the process of defining jobs since it provides a browser interface for user input and automatically generates separate job specification files for each distinct set of user inputs.

When a job specification file is directly edited to define a single job, the file may reside in a directory located in the development server 104. Once the job specification is created, an instance of it may then be created (instantiated) in the server 104. Multiple instantiations of a single job specification may be made. Each instance of the job runs on the server 104 until an end state is reached. To run the job again, the same job specification may be recompiled to create a new job instance. The new job instance may then be invoked.

To set up a workflow template to a create a job, five main components may be utilized:

(1) The workflow template file itself, which defines the workflow rules through a set of workflow markups and a set of general configuration instructions;

(2) An instantiator CGI that interprets the workflow rules and data from a user, produces browser graphics and prompts, generates a job specification, and instantiates a job;

(3) A browser-based graphical user interface (GUI);

(4) A job specification file that can be generated by the instantiator CGI; and

(5) The server-side workflow subsystem.

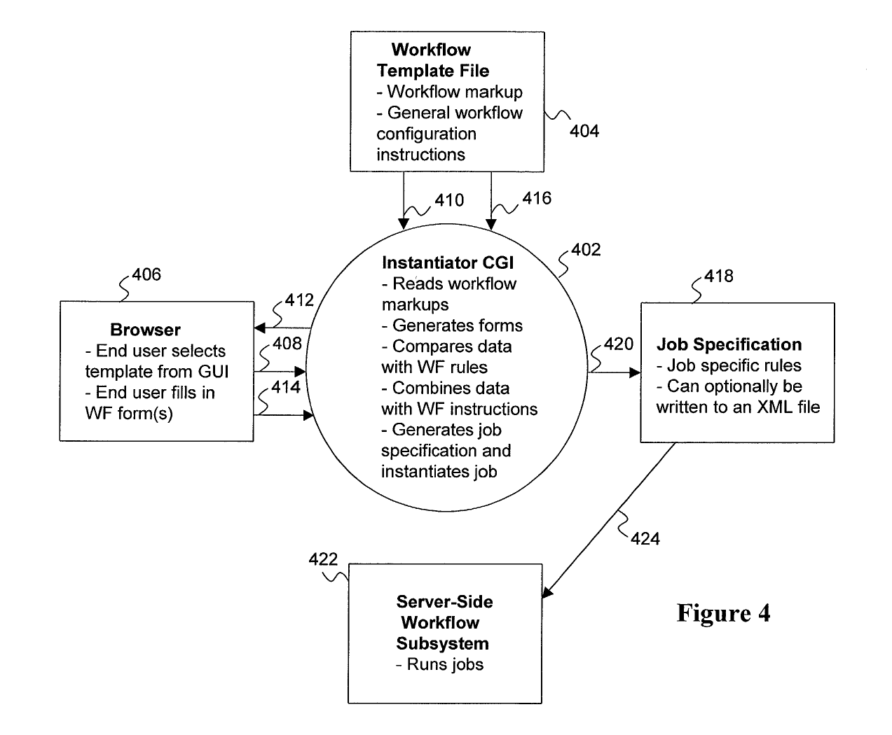

FIG. 4 illustrates diagrammatically these components and how they work together. The instantiator CGI 402 generally creates and displays the workflow information form based on information in the workflow template file 404. In addition, the instantiator CGI 402 evaluates data entered by users based on the workflow rules in the workflow template file 404, combines user-entered data with general workflow configuration instructions to create a job specification and instantiates the job specification on the development server 104 (FIG. 1) and starts (invokes) the job. The instantiator CGI 402 is an executable file that preferably resides in the server 104. Users enter data into a workflow form using the browser interface GUI 406.

In the browser interface GUI 406, a user selects a workflow template, such as from a “File>New File,” “File>Edit File,” or “File>Create New Job” menu item. This is illustrated in FIG. 4 by an arrow 408. The instantiator CGI 402 reads a file (e.g., “available_templates.ipl”) to determine which workflow template files are available for that given area or file content.

The instantiator CGI 402 goes to the specified workflow template file 404 and reads the workflow markup, which consists of Perl instructions residing in the workflow template file's template script element(s) (also referred to as “<template_script>” elements). This is illustrated in FIG. 4 by an arrow 410.

Based upon the workflow markup, the instantiator CGI 402 creates one or more workflow forms into which a user can enter workflow configuration information via the browser 406. This is illustrated in FIG. 4 by an arrow 412. A user working through the GUI 406 fills in the workflow form and submits it back to the instantiator CGI 402. This is illustrated in FIG. 4 by the arrow 414.

The instantiator CGI 402 consults the rules in the workflow markup of the workflow template file 404 to verify the validity of the data entered by the user. This is illustrated in FIG. 4 by the arrow 412. If the data meets all necessary criteria, it is parsed by the instantiator CGI 402. If the data does not meet all the necessary criteria, the interface 406 re-prompts the user to so that data can be re-entered.

After determining that the workflow form contains valid data, the instantiator CGI 402 combines the data with the general instructions from the workflow template file 404 to create job specification 418 (and optionally a job specification file) for the specific job. This is illustrated in FIG. 4 by an arrow 420. If a job specification is created, it is equivalent to the file created using the manual, direct-edit technique previously described. The job is instantiated into the server 104 (FIG. 1) and started in the server-side workflow subsystem 422. This is illustrated in FIG. 4 by an arrow 424. These actions would be performed manually if using the manual, direct-edit technique.

When a job specification is not created, (which is typically the case), the instantiator CGI 402 performs the functional equivalent of writing a job specification file to disk and then invoking commands to instantiate and invoke the job instance.

The workflow template file 404 is preferably an XML file that contains any or all of the elements that are valid in a job specification file. These elements form the set of general workflow configuration instructions shown in FIG. 4. In addition, the workflow template file 404 can contain <template_script> elements, including a set of directives to define the workflow markups also shown in FIG. 4.

All instructions residing within a <template_script> file may be interpreted by the instantiator CGI 402 as Perl code. Because the template files must be valid XML documents, all content in a <template_script> element should be declared as CDATA to protect it from interpretation by an XML parser. Together, all the <template_script> elements in a workflow template file may form a single Perl program. If a workflow template file contains more than one <template_script> element, all variables, functions, and libraries set in one element are preferably available in the others.

Each <template_script> element preferably contains arbitrary Perl code that can: define rules that the instantiator CGI 402 employs to combine user-entered data with hardcoded workflow XML from the workflow template file and/or programmatically generated workflow XML produced within <template_script> elements; programmatically generate a job specification (and/or intersperse hard-coded XML job specification information with programmatically generated XML); optionally send the job specification to a file in addition to, or instead of, instantiating it into the workflow subsystem (this can be helpful to determine exactly what XML is being produced); define rules that validate user-entered data; define custom error messages to be displayed when data validation rules are not satisfied; inspect incoming data and execute coded rules based on this data (for example, when an author's name is “Andre” three approvers may be required, whereas, when the author's name is “Jon” only one approver is required); merge incoming data with hard-coded workflow XML from the workflow template file; and determine the “look and feel” of the workflow forms.

Accordingly, the directives control the “look and feel” of workflow forms generated by the instantiator CGI 402, control the data collection, validation, and error messages displayed in workflow forms, return the number of elements in a tag, insert the HTML-encoded data associated with the form into the job specification, and insert text into a job specification programmatically.

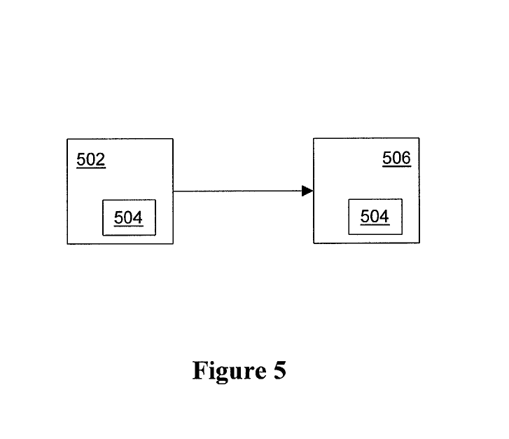

FIG. 5 illustrates another example of a simple workflow. As shown in FIG. 5, a task is performed in a work area 502 in which files 504 are modified. Once the files 504 have been modified, they are provided to a work area 506. In the work area 506 further tasks may be performed on the files 504.

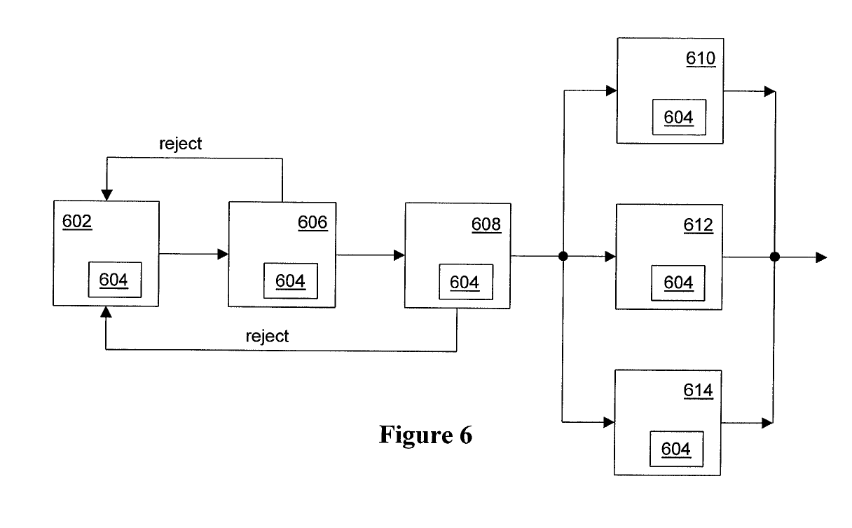

FIG. 6 illustrates another example of a workflow. A task is performed in a work area 602 on files 604. Once the work is completed, the files 604 are reviewed in an area 606. If more work is required, a reject indication is sent from the area 606 to the area 602. However, assuming the files 604 are approved in the area 606, the files 604 are sent to a work area 608. In the area 608, link checking may be performed to ensure that the changes made in the work area 602 did not adversely affect any links (e.g., hyperlinks). If a link was adversely affected, the files are returned to the area 602 by sending a reject indication from the area 608 to the area 602. Assuming, however, that the link checking finds no problems, then the files 604 are sent to areas 610, 612, 614 where additional work is performed on the files or review of the files is undertaken. The files may be simultaneously transferred to the areas 610, 612, 614 and may be simultaneously modified or reviewed in the areas 610, 612, 614.

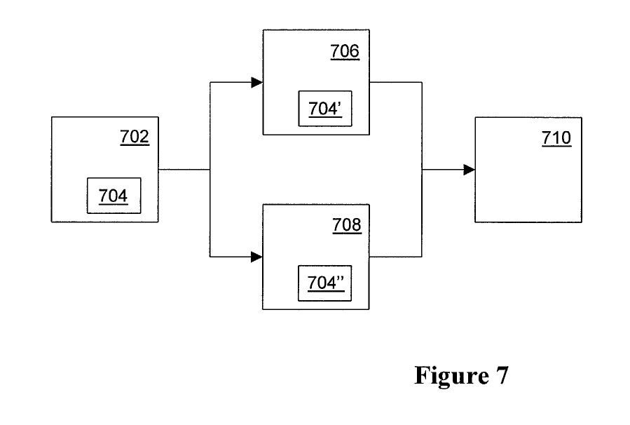

FIG. 7 illustrates yet another example of a workflow. In a work area 702, files 704 are modified by performance of a specified task. The files 704 may then be passed to work areas 706 and 708 where additional tasks are performed. Note that files can be copied to a new work area by a task or a new task can act on the same files. Once the work is completed in the work areas 706 and 708, the files 704, as modified by each of the work areas 706 and 708, are merged in a work area 710 prior to further processing. Because tasks are performed in the areas 706 and 708 in parallel, the files 704 may be copied or duplicated from an original and the copies 704′, 704″ may be modified differently by each of the areas 706 and 708. Accordingly, the files 704′, 704″ from each area 706 and 708 may be merged and the differences reconciled prior to performing further tasks. This merging may be performed in a variety of ways, however, in the preferred embodiment, merging is performed by performing an operation in which changes to the copied files are incorporated into the original file. The merger can occur when at least one task is done, when all of the tasks are done or whenever any one task is done. The configuration of the code can define when the merger is to occur.

As an example of a merger, a first set of files to be merged may be copied into a work area. Then, a second set of files may be copied into the area. In copying the second set of files, conflicts between the second set and the first set may be identified and reconciled. For example, the owner of the task that produced the second set of files may perform the reconciliation through a user interface.

Referring to FIG. 7, merging the files includes comparing the files 704′, 704″ to each other, retaining like elements, deleting elements deleted in either area 706 or 708, adding elements added in either area 706 or 708 and modifying elements modified in either area 706 or 708. If a conflict exists, such as where a same element is modified differently in the areas 706 and 708, then further reconciliation may be performed. For example, this may involve returning the files to the areas 706 and 708. Preferably, however, such conflicts are avoided by limiting the tasks performed in parallel to tasks, which are unlikely to result in conflicting modifications being made to the same element of a file.

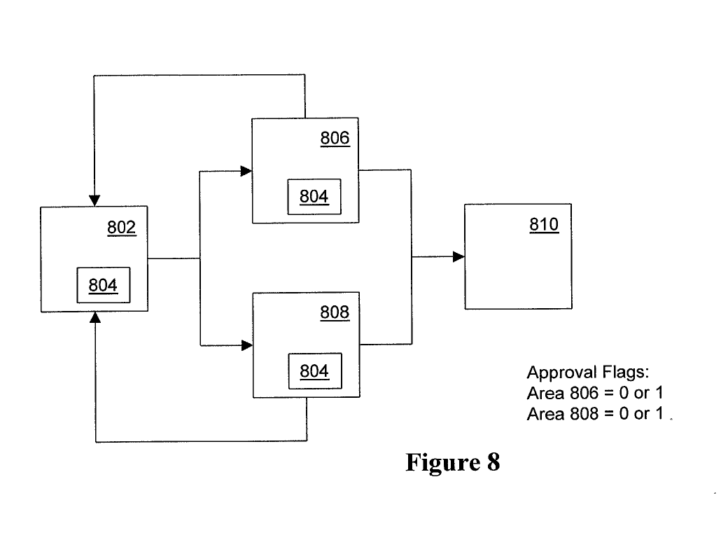

FIG. 8 illustrates a further example of a workflow. In a work area 802, files 804 are modified according to an assigned task. The files 804 are then sent to areas 806 and 808 for review. An editor may review the files and/or make changes to the files depending upon whether the task is designated as read-only. Assuming the files 804 are approved in both areas 806 and 808, the files are sent to a work area 810 for performing a further task. This may include publishing the changes to the files for incorporation into an original file.

To ensure that approval is obtained from each area 806 and 808 prior to performing any tasks in the area 810, an approval flag is provided corresponding to each area 806 and 808. When both flags are set, then this indicates that files may proceed in the area 810. Alternately, rather than requiring approval by each reviewer, approval of only one reviewer may be required. In which case, only one of the flags need be set prior to passing the files to the area 810. Assuming additional entities are reviewers, approval may be required of various combinations of the reviewers, such as a majority of reviewers, or approval may be required of a designated reviewer along with the approval one or more of a group of other reviewers.

Assume, however, that approval is required in both areas 806, 808 and that the files 804 are reviewed in the area 808 and approved. In which case, the approval flag for the area 808 is set. Assume also that the files 804 are reviewed in the area 806, but are rejected. Then, a rejection indicator may be sent from the area 806 to the area 802 and the files 804 may be returned to the area 802 for further modification. In response to the rejection, the approval flag, which was previously set for the area 806, is preferably reset. This is to ensure that the files 804, as modified in response to the rejection in the work area 806, are again reviewed in the work area 808 prior to further processing in the area 810. Thus, where multiple approval tasks are required for work done to a file, a flag may be set when the file is approved and may be reset should any other one of the approvals be denied. Thus, if the file is modified in response to a rejection, then all approvers must approve the modified file. When all such flags are set, the file may be passed on for further work, such as to another workstation.

While the foregoing has been with reference to particular embodiments of the invention, it will be appreciated by those skilled in the art that changes in these embodiments may be made without departing from the principles and spirit of the invention, the scope of which is defined by the appended claims. For example, the invention may include the utilization of dedicated processors, webservers configured to receive and route browser requests, application servers, state servers and other types of computer processors configured to communicate amongst each other and that may be connected to one or more networks, including a Local Area Network (LAN), an intranet and the Internet. However, it will be appreciated by those skilled in the art, such implementation of such devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although this embodiment is described and illustrated in the context of devices and systems for exchanging data among users of a computer system or network, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers connected to the Internet via individual modems or other communication means such as wireless communications.

The invention may also involve a number of functions to be performed by one or more computer processors, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively.

What is claimed is:

1. A method for controlling workflow for website development comprising:
selecting a workflow template from among a plurality of workflow templates stored in computer-readable memory, the workflow template having rules which constrain work to progress according to a predetermined arrangement of tasks;
creating a workflow form based upon the workflow template;
filling out the workflow form based upon user input;
combining the user input with the workflow template file, thereby forming a job specification in the memory; and
performing a job in accordance with the job specification.

2. The method according to claim 1 further comprising verifying validity of the user input by applying specified validation rules included in the template file.

3. The method according to claim 2 wherein said verifying is performed prior to said combining.

4. The method according to claim 1 wherein said job specification comprises a hierarchy of sections including an initial section that defines a characteristic of the job specification and a plurality of task sections, each of which describes specific tasks to occur in the job.

5. The method according to claim 1 wherein said creating the workflow form is performed by a common gateway interface.

6. The method according to claim 1 wherein said combining is performed by a common gateway interface.

7. The method according to claim 1 wherein said filling out the workflow form is performed through a browser-based graphical user interface.

8. The method according to claim 1 wherein said workflow template is an XML file.

9. The method according to claim 8 wherein said XML file includes Perl instructions specifying the tasks to be performed wherein the Perl instructions are declared as CDATA.

10. The method according to claim 1 wherein said performing the job comprises users modifying website content files.

11. The method according to claim 10 wherein at least one task specifies a sending an email notification to one of the users regarding said modifying website content files.

12. The method according to claim 10 wherein said modifying includes modifying said website content files in serial order.

13. The method according to claim 10 wherein said modifying includes modifying said website content files in parallel.

14. The method according to claim 12 further comprising merging said website content files modified in parallel.

15. A method for controlling workflow for website development comprising:
copying a work file from an original file defining content of a website;
performing tasks according to a job specification wherein the job specification constrains work to progress according to a predetermined arrangement of tasks including performing multiple tasks in parallel and wherein individual copied work files are modified by each of the multiple tasks thereby creating a modified file for each task; and
merging the modified files created by the multiple tasks into a merged file to incorporate modifications made in parallel to the original file.

16. The method according to claim 15 wherein said merging is performed while performing the multiple tasks.

17. The method according to claim 15 wherein said merging is performed after at least one of the multiple tasks is completed.

18. The method according to claim 15 wherein said merging is performed after all of the multiple tasks are completed.

19. The method according to claim 15 wherein said merging comprises comparing said modified files to each other, retaining like elements, deleting elements deleted from any of said modified files, adding elements added to any of said modified files and modifying elements modified in any of said modified files.

20. The method according to claim 15 wherein after creating one of said modified files, the method further comprises submitting the modified file containing proposed changes to the original file for approval of proposed changes by a one or more entities.

21. The method according to claim 20 wherein if the proposes changes are approved by all of the one or more entities, the method further comprises publishing the changes to be incorporated into the original file.

22. The method according to claim 20 wherein if the changes are approved by a majority of the one or more entities, the method further comprises publishing the changes to be incorporated into the original file.

23. The method according to claim 15 wherein said workflow template is an XML file.

24. The method according to claim 15 further comprising deploying the merged files to the website.

25. A method for controlling workflow for website development comprising:
creating a job specification in computer readable memory, the job specification specifying an arrangement of tasks to be performed on website content files;
modifying the website content files wherein said modifying is constrained to progress in accordance with the arrangement of tasks; and
deploying the modified website content files to the website.

26. The method according to claim 25 wherein said job specification is an XML file.

27. The method according to claim 26 further comprising directly editing the XML file.

28. The method according to claim 26 further comprising creating the job specification using a workflow template.

29. The method according to claim 28 wherein said workflow template is an XML file.

30. The method according to claim 25 wherein users perform said modifying and wherein at least one task specifies a sending an email notification to one of the users regarding at least one other task.

31. The method according to claim 25 wherein said modifying includes modifying said website content files in serial order.

32. The method according to claim 31 wherein said modifying includes modifying said website content files in parallel.

33. The method according to claim 32 further comprising merging said website content files modified in parallel.
